(19) United States
(12) Patent Application Publication
(10) Pub. No.: US 2024/0314138 A1
(43) Pub. Date: Sep. 19, 2024

(54) GLOBAL POSITIONING SYSTEM BASED MULTI-FACTOR AUTHENTICATION FOR ZERO TRUST NETWORK ACCESS

(71) Applicant: Cisco Technology, Inc., San Jose, CA (US)

(72) Inventors: Jay Prakash Tiwari, Princeton, NJ (US); Gururajan Sundar Rao, Chennai (IN); Praveen Kumar Sheena Poojary, Jersey City, NJ (US); Senthil Kumar Chandramohan, Bangalore (IN)

(21) Appl. No.: 18/122,990

(22) Filed: Mar. 17, 2023

(51) Int. Cl. H04L 9/40

(52) U.S. Cl. CPC H04L 63/107; H04L 63/0861; H04L 63/20; H04L 2463/082

(57) ABSTRACT

Techniques for determining whether to send an MFA push notification are described. An indication of a request for a user account to access the application service via an endpoint device is received at an MFA service from an application service. A first geolocation of the endpoint device and a second geolocation of an MFA-registered device associated with the user account are received at the MFA service. Using the first and second geolocation, determine whether the endpoint device and the MFA-registered device are within a threshold proximity. When the endpoint device and the MFA-registered device are within the threshold proximity, allows a push notification to be transmitted to the MFA-registered device requesting authentication to grant access to the user account by the endpoint device, and when the endpoint device and the MFA-registered device are not within the threshold, refrain from transmitting the push notification.

### TECHNICAL FIELD

The present disclosure relates generally to techniques for, among other things, using device location of a primary device and a secondary device to allow or deny MFA push notifications to be sent to allow or deny connections to network resource(s), and to terminate connections based on device location monitoring.

### BACKGROUND

Multi-Factor Authentication (MFA) techniques are becoming increasingly prevalent as a means of procuring access to electronic devices, applications, and the like. MFA is an electronic authentication method in which a user is granted access after successfully presenting two or more pieces of evidence (e.g., factors) to an authentication mechanism. MFA combines two or more independent credentials. For example, the credentials may include presenting knowledge (e.g., something only the user knows such as a password), possession (e.g., something only the user has such as a security token), and/or inherence (e.g., something only the user is such as using biometric verification). Techniques for providing a two-factor authentication often involve the use of electronic devices. For example, MFA techniques may require a user to confirm a push notification sent to a possession (e.g., a mobile device) of the user (e.g., something only the user has).

The goal of MFA is to present multiple defenses that make it more difficult for an unauthorized person to access a target. If one factor is compromised (e.g., a password is stolen) the attacker still has at least one more barrier to breach before successfully breaking into the target. For example, if an unauthorized perpetrator has stolen a password for an account that is not theirs, they may attempt to log into the account using the correct password, but with MFA a push notification may be sent to a second device, such as a cell phone, registered to a user associated with the account, requesting a second factor (e.g., a biometric verification) before the account can be accessed. As the cell phone will typically be physically with the user associated with the account, the user will know not to provide the second factor and the perpetrator will be unsuccessful.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example architecture that may implement various aspects of the technologies directed to using device location of a primary device and a secondary device to allow or deny MFA push notifications to be sent to allow or deny connections to network resource(s), and to terminate connections based on device location monitoring as described herein.

FIG. 2 illustrates an example of using device location of a primary device and a secondary device to allow or deny MFA push notifications to be sent to allow or deny connections to network resource(s), and to terminate connections based on device location monitoring as described here.

FIG. 3 illustrates an example of step-by-step communications to allow or deny MFA push notifications to be sent to allow, deny, or terminate connections to a network resource(s).

FIG. 4 is a flow diagram illustrating an example method associated with the techniques described herein for location based Multi-Factor Authentication for zero trusted access.

FIG. 5 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes various techniques for determining whether to send an MFA push notification to an MFA registered device based on the location of an endpoint device attempting access to an account and the MFA registered device. By way of example, and not limitation, the techniques described herein may include receiving, at a Multi-Factor Authentication (MFA) service and from an application service, an indication of a request for a user account to access the application service via an endpoint device, the request including login credentials associated with the user account. The techniques may also include receiving, at the MFA service, a first geolocation of the endpoint device that sent the request. In addition, the techniques may include receiving, at the MFA service a second geolocation of an MFA-registered device that is associated with the user account. The techniques may also include determining, using the first geolocation and the second geolocation, whether the endpoint device and the MFA-registered device are within a threshold proximity to each other. In response to the endpoint device and the MFA-registered device being within the threshold proximity to each other, the techniques may include determining, at the MFA service, to allow a push notification to be transmitted to the MFA-registered device requesting authentication to grant access to the user account by the endpoint device. In response to the endpoint device and the MFA-registered device not being within the threshold proximity to each other, the techniques may include refraining from transmitting the push notification to the MFA-registered device.

Additionally, the techniques described herein may be performed as a method and/or by a system having non-transitory computer-readable media storing computer-executable instructions that, when executed by one or more processors, performs the techniques described above and herein.

### EXAMPLE EMBODIMENTS

As noted above, MFA techniques are becoming increasingly prevalent as a means of procuring access to electronic devices, applications, and other secured resources. While the goal of MFA is to present multiple defenses that make it more difficult for an unauthorized person to access a target, there are still situation in which a perpetrator is able to get around the multiple layers of defense. One popular way in which hackers get around MFA is a technique known as MFA fatigue. When an application's MFA is configured to use push notifications, a user of a legitimate account sees a prompt on their mobile device when someone tries to log in with the user's credentials (e.g., username and password). These MFA push notifications ask the user to verify the login attempt and will show where the login is being attempted. An MFA Fatigue attack is when a hacker attempts to log in with stolen credentials over and over, by running a script for example. This results in an endless stream of MFA push requests sent to a mobile device of the account owner. The endless stream of push requests is designed to break down the target's cybersecurity posture and inflict a sense of “fatigue” regarding the push requests. Ultimately the target may become so overwhelmed that they accidentally approve or accept an MFA request to stop the endless stream of notifications they are receiving. MFA fatigue has proven to be a very successful technique for breaching large well-known organizations.

Additionally, once a legitimate workflow has been authenticated based on a successful MFA authentication, there is no way to continuously monitor the authenticated workflow and terminate the session if a security policy violation occurs, such as when the authenticated user of an endpoint device is away from or not within a proximity of the endpoint device. As an example, a user may start a session with Office365 on their computer (e.g., laptop, desktop, etc.) and authenticate the session by responding positively to an MFA notification pushed to their cell phone. However, at some point after the session has been authenticated and while the session is still active, the user may leave the room or even the premises where their computer is located, thereby leaving their computer unattended with an active Office365 session running and vulnerable to access by unauthorized users.

This disclosure is directed to techniques that, among other things, utilize the proximity of a primary client or endpoint device (e.g., a laptop a user in attempting to log into a user account with) to a secondary or MFA-registered device (e.g., authenticating device, the cell phone in the above example) which is registered with an MFA service to allow or deny connections to secured resource(s), as well as terminate existing connections to the secured resource(s) (e.g., application(s), service(s), etc.). In some examples, the technologies described in this disclosure may include establishing a Global Positioning System (GPS) location of the connecting device and the GPS location of the MFA-registered device to be used to determine whether to send a push notification to the MFA-registered device in order to complete an MFA and allow connection to the secured resource requested. Additionally, the GPS locations of the primary endpoint device and the MFA-registered device may be continuously monitored throughout the life of the authenticated session such that when the MFA-registered device moves away from the primary endpoint device and is more than a threshold proximity away from the primary endpoint device, the existing session may be terminated.

Turning back to the above-described example, in response to the user leaving the room or the premises where their computer is located, the technologies described in this disclosure would cause the user's Office365 session to be terminated, at least assuming that the user has taken their cell phone with them upon leaving their computer unattended. Upon the user leaving the room or the premises where the computer is located, and assuming that the user took their cell phone with them, the connection would fail as the cell phone moved out of the threshold proximity of the computer. In response to this, the Office365 session would be terminated.

To implement techniques described herein, a user may register a device with an MFA service. For example, a user typically will register their cell phone with the MFA service. The MFA service will send a push notification, to authenticate an attempted login of a user account, to the registered device when an attempt is made on a primary endpoint device to login to an account associated with the user. When an application service receives a request for a user account to access the application service via a primary endpoint device, the request to access the application service includes login credential for the user account, for example a username and password. Continuing with the above example, when a user attempts to login to an Office365 account at a laptop with the user's username and password, the application service receives the credential (username and password) and sends them to a Remote Authentication Dial-In User Service (RADIUS) or equivalent, for verification. If the login credentials are valid the RAIUS server will request an MFA proxy to initiate a secondary authentication. The MFA service receives the request to send a push notification to a secondary device that is an MFA-registered device, registered as an authenticator for the user account that the primary endpoint device is requesting to access. When the MFA service receives the request, the MFA service will check the GPS location of both the primary endpoint device and the secondary MFA-registered device that are continuously monitored by the MFA service and determine whether the endpoint device and the MFA-registered device are within a threshold proximity of one another.

If the MFA service determines that the requesting endpoint device and the MFA-registered device are within the threshold proximity the MFA service will send a push notification to the MFA-registered device requesting secondary authentication. In this case, when the endpoint device and the MFA-registered device are within the threshold proximity, the MFA service can conclude with relative certainty, that the actual user associated with the user account being accessed, is the proper user. For example, if a user attempts to access an Office365 user account with their laptop, and the user has their MFA-registered cell phone on their person, putting the endpoint device and the MFA-registered device within close proximity, the MFA service can reasonably conclude that the user attempting to login is the proper user for that user account, and the MFA service will send the push notification to the MFA-registered device.

On the other hand, if the account credentials for a user account of an application service have been stolen, and those valid credentials are used by a hacker to attempt to fraudulently access the account, the location of the endpoint device attempting to login to the user account, will assuredly be out of range of the threshold proximity. For example, a hacker with the stolen credentials would likely be attempting access to the account from a different country, region of a country, or at least a location a mile or kilometer or more away from the location of the MFA-registered device. In this example, the MFA service will not send a push notification to the MFA-registered device, thus, preventing any attempt at MFA fatigue by the hacker. In addition, the MFA service may instead send a notification to the MFA-registered device that credentials associated with the user account may have been stolen or otherwise compromised, and prompt for the user associated with the user account to initiate a password change for the user account.

A threshold proximity between an endpoint device and an MFA-registered device, may be user defined or defined by an enterprise organization to which the user account is associated. However, the threshold proximity will most likely be limited to a proximity in which a person may reasonable be in physical contact with both the endpoint device and the MFA-registered device, or perhaps a few steps away, depending on an organizations security policy.

Additionally, once a session has been established between a primary device and a secured resource according to techniques describe herein, the MFA service will continuously monitor the GPS location of both the primary device and the MFA-registered device to ensure that they stay within a threshold proximity. Once the threshold proximity is breached, the MFA service can terminate the session with the secured resource. This will ensure that once a user having the MFA-registered device on their person, steps away for the primary device connected to a secure resource, the primary device will not be susceptible to unauthorized activity by someone other than the proper registered user.

In some examples, a user or enterprise organization associated with the secure resource(s) to which a login attempt is made, may permit the primary endpoint device and the MFA-registered device to exceed the threshold proximity if the primary endpoint device is located at a predetermined acceptable geolocation associated with the user account, and still transmit a push notification to the MFA-registered device. For instance, if a primary endpoint device attempting to access a secured resource is determined to be located at the residence of a user associated with the secured resource, but the MFA-registered device is determined to be located at distance that exceed the threshold proximity. For example, if the owner of an account with a secure resource, such as a streaming service, is at their place of employment and has the MFA-registered device on their person (e.g., cell phone), but an endpoint device is attempting to login to the account at the owner's place of residence, the MFA service may still send a push notification to the MFA-registered device even though the threshold proximity is exceeded. Then the owner of the account may determine if it is appropriate to grant access to their account. Such a scenario may occur when an owner of an account, having their cell phone with them, is at work, or otherwise not home, and a family member, who is located at home, would like to watch something on a streaming service for which the cell phone is the MFA-registered device.

In some examples, the techniques of this disclosure may be used in cases where the same device can act as primary authentication device and secondary authentication device for the secured session. For instance, an MFA-registered device (e.g., cell phone) may be used to log into a user's email account. In such cases, it is not possible to ensure the primary device and the MFA-registered device are within a threshold proximity using GPS location. Thus, in this case, the device authenticator's HTTPs sends device information (e.g., GPs location, International Mobile Equipment Identity (IMEI), etc.) to the MFA service to validate the device information which has been collected from the MFA applications and registered with the MFA service. If the device information corresponds to the registered device information, then the device biometric or device login from the MFA application is invoked, making the secondary authentication the device authentication.

As used herein, the term “primary device”, “client device”, or “endpoint device” means the authenticated device that is attempting to establish an authenticated/secured session. Additionally, the term “MFA-registered device” means the authenticating device that may receive an MFA push notification to authenticate the session for the primary device. In many cases, a primary device would be a user's laptop or desktop computer, and an MFA-registered device would be the user's cell phone or other mobile device (e.g., tablet). However, it is to be understood that other combinations of primary and MFA-registered devices exist, as those having ordinary skill in the art will understand. For instance, a cell phone or tablet may be a primary device and a laptop or desktop computer may be an MFA-registered device in an MFA workflow, in some examples. As another example, a tablet may be a primary device and a cell phone may be an MFA-registered device, in some instances. In addition, GPS location is used herein to describe the means of determining a geolocation for a device, however it is to be understood by those having ordinary skill in the art that other means of determining the geolocation of a device may be used.

According to the technologies of this disclosure, several advantages and improvements in computer-related technology can be realized. For example, the techniques described herein prevent MFA fatigue by ensuring the primary device and the MFA-registered device are within a threshold proximity for the initial determination of whether to allow a push notification to be sent to the MFA-registered device in order to complete an MFA and allow connection to a secured resource. In addition, the continuous evaluation of the geolocation of both the primary device and the MFA-registered device to determine if proximity exceeds a threshold proximity and should result in session termination is described. This improves the functioning of MFA systems by providing another layer of security and authentication. Additionally, the techniques of this disclosure allow for the termination of existing sessions between a primary device and a resource based on device proximity, which is indicative of whether the user is actually present at the primary device. This allows organizations to ensure even greater security for their resources by ensuring that the true user of the primary device be in proximity of the primary device in order for the primary device to have access to the resource. These and other advantages and improvements will be readily apparent to those having ordinary skill in the art.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

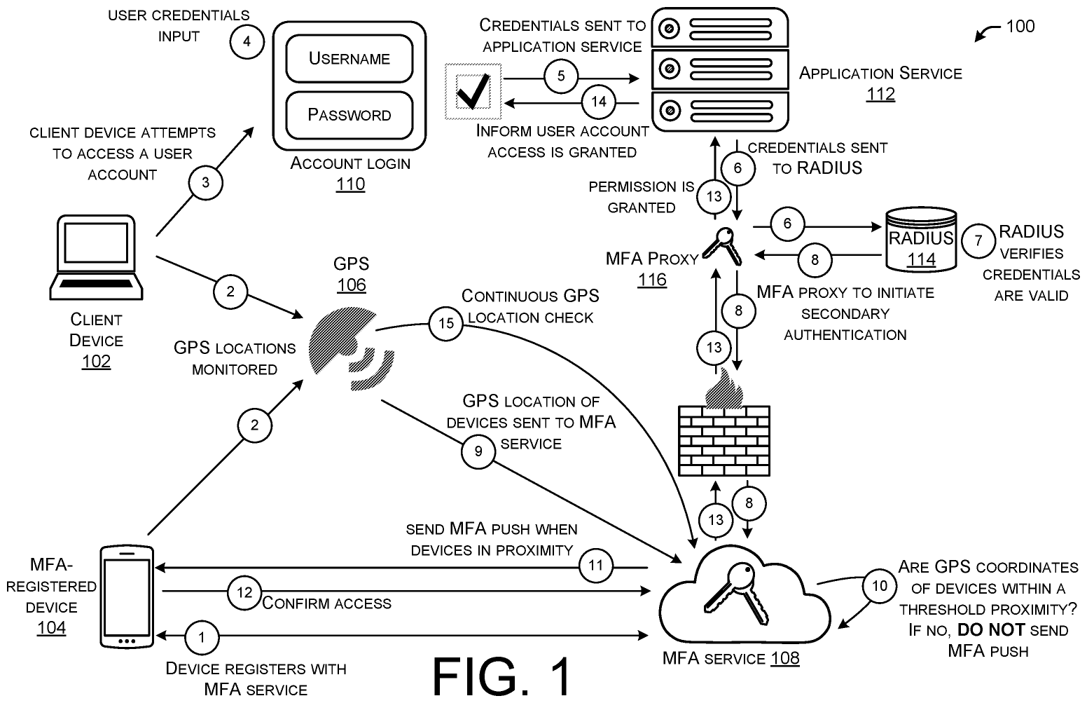

FIG. 1 illustrates an example architecture 100 that may implement various aspects of the technologies described herein. In FIG. 1, various example steps (1-15) associated with the technologies described herein are shown. These steps illustrate an example data flow/process associated with using device proximity of a primary device and an MFA-registered device to allow or deny push notifications to be sent for MFA verification, as well as to use device location to determine whether to terminate existing connections between the primary device and a resource(s).

The architecture 100 includes a primary client device 102 and an MFA-registered device 104. In the illustrative example, the primary client device 102 represents a laptop and the MFA-registered device 104 represents a cell phone. However, as noted above and herein, the primary device 102 and the MFA-registered device 104 may be any type of electronic device capable of communicating data over a network.

The architecture 100 also include a geolocation system, illustrated in FIG. 1 as GPS 106 and an MFA service 108 to facilitate Multi-Factor Authentication.

At (1) the MFA-registered device 104 registers with the MFA service 108 to be a secondary authentication device for a Multi-Factor Authentication for secured resources. For example, the MFA-registered device 104 is authorized to receive a push notification from the MFA service 108 to authenticate an attempted login of a secured resource. At (2) the GPS location of the client device 102 and the MFA-registered device 104 are monitored.

At (3) the client device 102 attempts to access a user account by inputting user credential at (4). The user credentials are input to an account login 110. Typically, the user credentials include a username and password associated with a user account of the secure resource as shown. At (5) the user credentials are sent to the secured resource to which access is being attempted. As illustrated in FIG. 1, the secured resource is an application service 112. However, the secured resource may be any appropriate resource such as an application, a web service, a virtual private network (VPN) headend service, a container-based application running on an application orchestration system, or the like. In some examples, the resource(s) may be cloud based resources, on-prem resources, and/or the like.

At (6) the application service 112 sends the user credentials to a RADIUS 114 server or the equivalent to determine whether the user credentials are valid for the account being accessed. At (7) RADIUS 114 will verify the whether the credentials are valid. If they are not, the process does not continue, and the primary device 102 is notified on the account login 110 that the user credentials are not correct, and the login attempt is unsuccessful. If RADIUS 114 determines the credentials are valid, at (8) RADIUS 114 will notify an MFA proxy 116 to initiate a secondary authentication factor in Multi-Factor Authentication process. However, instead of automatically sending a push notification to the MFA-registered device 104 to authorize the login attempt, the MFA proxy 116 sends an indication to the MFA service 108 of the login attempt, and at (9) the MFA service 108 uses the GPS location of both the client device 102 and the MFA-registered device 104 to determine at (10) whether the GPS coordinates of the devices are within a threshold proximity. If the GPS locations of the client device 102 and the MFA-registered device 104 are not within the threshold proximity, the MFA service 108 will refrain from sending a push notification to the MFA-registered device. Instead, there MFA service 108 may determine that there is a likelihood that the user login credentials have been compromised and the MFA service may send a notification to the MFA-registered device of the potential compromise and prompt for a password change.

If the MFA service 108 determines that the client device 102 and the MFA-registered device 104 are within the threshold proximity, the MFA service will send the push notification to the MFA-registered device 104 at (11). The user associated with the MFA-registered device 104 may then confirm access at (12) when the MFA push notification is received. When the MFA service 108 receives the confirmation from the MFA-registered device 104, the MFA service 108 will send a notification that permission is granted at (13) to the application service 112. At (14) the application service will indicate that user account access is granted and proceed to grant access to the user account of the application service associated with the user credentials.

In addition, at (15) the GPS 106 will continuously monitor the locations of the client device 102 and the MFA-registered device 104 and the location will be continuously sent to the MFA service 108. The MFA service 108 will monitor the GPS locations of the client device 102 and the MFA-registered device 104 to determine whether the threshold proximity between the two devices is breached. If the proximity threshold is exceeded, the MFA service 108 will terminate the connection between the client device 102 and the application service 112.

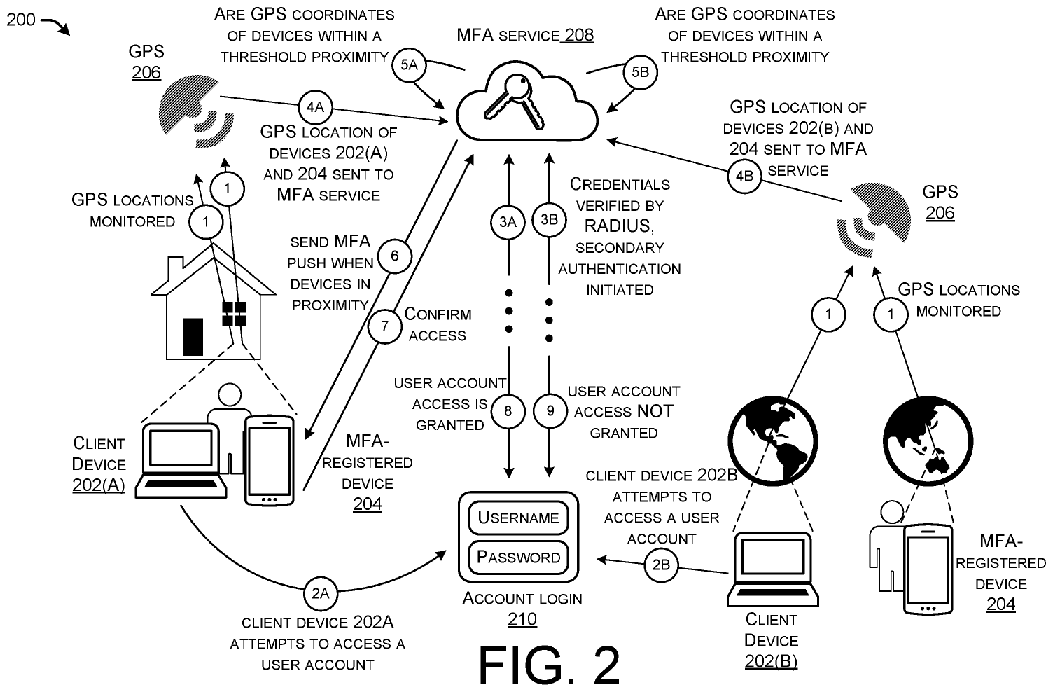

FIG. 2 illustrates an example architecture 200 that may implement various aspects of the technologies described here. The example architecture 200 is similar to example architecture 100 described with reference to FIG. 1, but illustrates two scenarios, one in which a push notification is sent from an MFA service for MFA verification and a second in which a push notification is not sent. The various example steps (1-9) associated with the technologies described herein are shown. These steps illustrate an example data flow/process associated with using device proximity of a primary device and an MFA-registered device to allow or deny push notifications to be sent for MFA verification, as well as to use device location to determine whether to terminate existing connections to resource(s).

The architecture 200 includes a first primary client device 202(A) and a second primary client device 202(B). Architecture 200 also include an MFA-registered device 204. Two difference scenarios are illustrated to show different aspects of the techniques for determining whether to send an MFA-registered device a push notification for MFA verification described herein. The architecture 200 also includes GPS 206, an MFA service 208, an account login 210 for accessing a user account associated with a secure resource(s). It should be noted that MFA-registered device 204 is one device, although it is illustrated in FIG. 2 twice, once with reference to client device 202(A) and once with reference to client device 202(B).

At (1) geolocations of client device 202(A), client device 202(B), and MFA-registered device 204 are monitored by GPS 206. At (2A) client device 202(A) attempts to access a user account by inputting user credentials at an account login 210. At a same or different time, client device 202(B) also attempts to access the same user account by inputting the user credentials at the account login 210. If the correct user credentials are input at (2A) and (2B), then at (3A) and (3B) the credentials are verified by RADIUS, and a secondary authentication for an MFA is initiated. At (4A) a GPS location of client device 202(A) and a GPS location of MFA-registered device 204 are sent to the MFA service 208. Similarly, at (4B) a GPS location of client device 202(B) and a GPS location of MFA-registered device 204 are sent to MFA service 208.

At (5A) the MFA service 208 determines whether the GPS coordinates of client device 202(A) and MFA-registered device 204 are within a threshold proximity. As shown in FIG. 2, client device 202(A) and MFA-registered device 204 are in close proximity, is a same house in a same room, both within physical reach of a user associated with the MFA-registered device. As such, at (6) the MFA service 208 will send an MFA push notification to the MFA-registered device 204. At (7) the user associated with MFA-registered device 204, knows they are the one attempting to access the user account via client device 202(A) and will confirm the access on MFA-registered device 204. When the MFA service 208 receives the MFA authentication, at (8) the MFA service sends notification that user account access has been granted and the client device 202(A) is granted access to the account.

In contrast, at (5B) the MFA service 208 determines whether the GPS coordinates of client device 202(B) and MFA-registered device 204 are within a threshold proximity. As shown in FIG. 2, client device 202(B) and MFA-registered device 204 are not in close proximity, in fact they are on opposite side of the world from each other. Thus, they are most definitely not within a threshold proximity. As such, a push notification for MFA authentication is not sent from the MFA service 208 to the MFA-registered device 204 prompting to grant access to the user account via client device 202(B). Instead, MFA service 208 may determine to prompt the MFA-registered device for a new password, as the user credential may have been compromised.

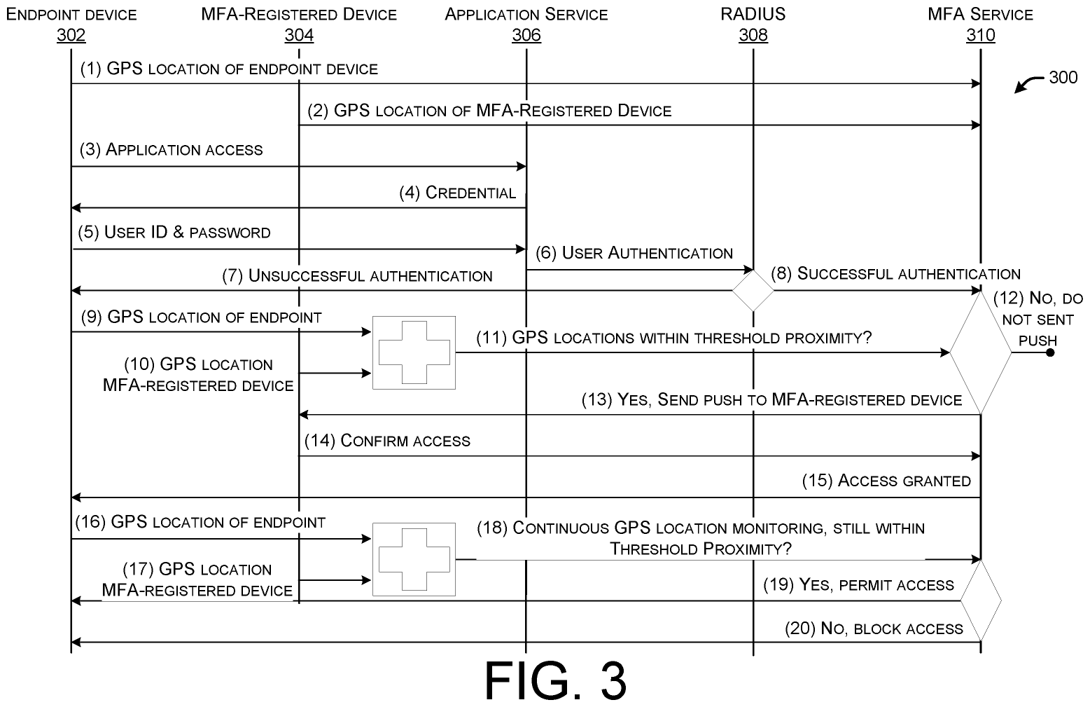

FIG. 3 illustrates an example step-by-step communication flow 300 to allow or deny a push notification to be sent to an MFA-registered device to allow or deny a connection to a network resource(s). At (1) the GPS location of an endpoint device 302 is sent to an MFA service 310, and at (2) the GPS location of MFA-registered device 304 is sent to MFA service 310. For example, with reference to FIG. 1, the MFA service 108 receives the GPS location of client device 102 and MFA-registered device 104.

At (3) endpoint device 302 attempts to access the application service 306. At (4) the application service 306 prompts for user credentials, and at (5) the user ID and password (the credentials) are input at the endpoint device 302 and sent to the application service 306. For example, referring again to FIG. 1, a user may attempt via the client device 102 to access the application service 112 by inputting user credentials (e.g., username and password) at account login 110.

At (6) once the user credentials are received by the application service 306, the application service sends the credentials to RADIUS 308 for verification. If the user credentials are not correct at (7) an unsuccessful authentication occurs and the endpoint device 302 is blocked from accessing a user account of the application service. If the user credentials are successfully verified by RADIUS, at (8) the MFA service 310 is notified of the successful user credential authentication. In addition, at (9) the GPS location of the endpoint device 302, and at (10) the GPS location of the MFA-registered device are compared at (11) to determine if the GPS locations are within a threshold proximity. For example, in FIG. 1 the GPS location of the client device 102 and the GPS location of the MFA-registered device 104 are compared to determine if they are within a threshold proximity of each other.

At (12) if the MFA service determines that the GPS locations of the endpoint device 302 and the MFA-registered device 304 are not within a threshold proximity of each other, the MFA service 310 will not send a push notification to the MFA-registered device. At (13) if the GPS location of the endpoint device 302 and the MFA-registered device 304 are within a threshold proximity of each other, the MFA service 310 will send a push notification to the MFA-registered device 304. For example, again referring to FIG. 1, if the GPS location of client device 102 and the GPS location of MFA-registered device 104 are within the threshold proximity of each other, MFA service 108 will send an MFA push notification to MFA-registered device 104.

At (14) if the MFA-registered device 304 confirms access after receiving the MFA push notification, at (15) access to the application service 306 is granted. For example, in FIG. 1, if the MFA-registered device 104 confirms access when the push notification is received, access to the user account of the application service 112 is granted at client device 102.

Additionally, at (16) and (17) the GPS location of the endpoint device 302 and the MFA-registered device 304 will be continuously monitored and at (18) the MFA service will determine whether the two devices are continuously within the threshold proximity of each other. If they stay within the threshold proximity, the MFA service will continue to permit access to the application service 306 by the endpoint device 302. If the threshold proximity between endpoint device 302 and MFA-registered device 304 exceeds the threshold proximity, at (20) the MFA service 310 will terminate the connection between the endpoint device 302 and the application service 306 and block access. If the endpoint device 302 wants to reconnect to the application service 306 a user must login again using their user credentials at (5). This will ensure that if user walks away, with the MFA-registered device 304 on their person, from the endpoint device 302 with an active connection to the application service 306, an unauthorized user may not be afforded access to the active connection, as once the threshold proximity is exceeded, the connection will be terminated.

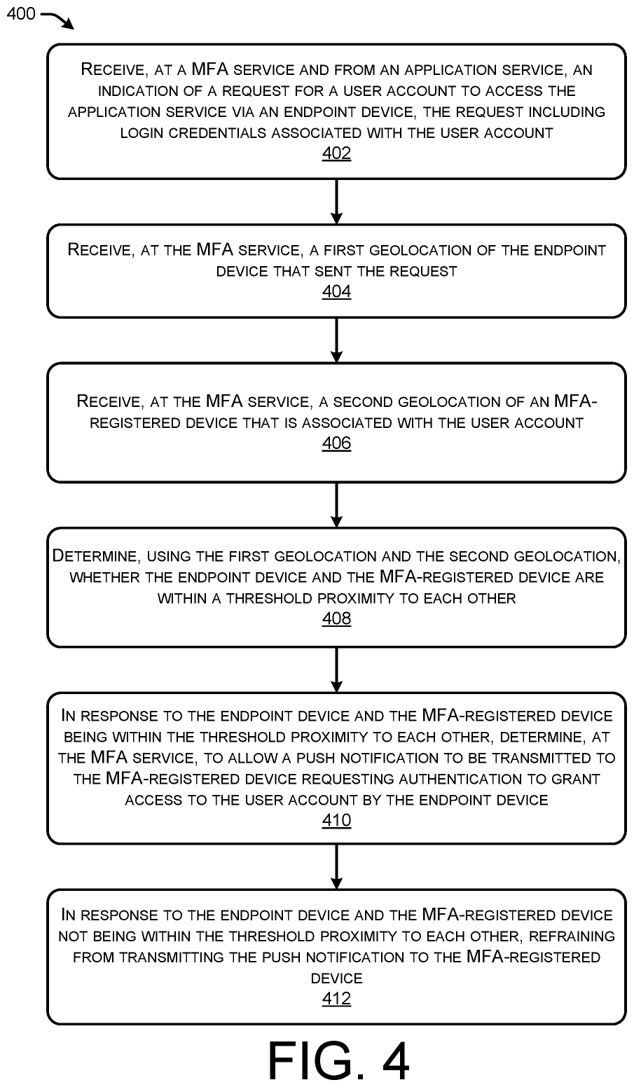

FIG. 4 is a flow diagram illustrating an example method 400 associated with the techniques described herein for determining whether to send a push notification to an MFA-registered device for MFA verification. The logical operations described herein with respect to FIG. 4 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 4 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

At operation 402, an MFA service receives an indication from an application of a request for a user account to access the application service via an endpoint device, the request includes login credentials associated with the user account. For example, with reference to FIG. 1 the MFA service 108 will receive an indication from the application service 112 that a request has been made at the client device 102 to access a user account with the application service 112. The access request includes user credentials, such as username and password, input into an account login 110. The application service 112 then sends the credentials to a RADIUS 114 server for verification, if the credentials are incorrect, the attempt is not successful and the endpoint client device 102 will not be allowed access. If the user credentials are valid, RADIUS 114 will request an MFA proxy to initiate a secondary authentication.

At operation 404, the MFA service receives a first geolocation of the endpoint device that sent the request. If the RADIUS server determines the user credentials are valid, and the MFA proxy initiates a secondary authentication, and the MFA service will check the geolocation of the endpoint device. For instance, with reference to FIG. 1 the MFA service 108 receives the GPS location of client device 102. In another example with reference to FIG. 2, the MFA service 208 receives the GPS location of client device 202(A) and client device 202(B).

At operation 406, the MFA service receives a second geolocation of an MFA-registered device that is associated with the user account. If the RADIUS server determines the user credentials are valid, and the MFA proxy initiates a secondary authentication, the MFA service will check the geolocation of the MFA-registered device. For instance, with reference to FIG. 1 the MFA service 108 receives the GPS location of MFA-registered device 104. In another example with reference to FIG. 2, the MFA service 208 receives the GPS location of client device 204.

At operation 408, using the first geolocation and the second geolocation, the MFA service device determines whether the endpoint device and the MFA-registered device are within a threshold proximity to each other. Conventionally, in a Multi-Factor Authentication, once user credentials are determined to be valid by RADIUS, a push notification will immediately be sent to the MFA-registered device to initiate a second factor in the MFA process. However, accordingly to techniques described herein, prior to determining whether to send a push notification to the MFA-registered device or not, the MFA service determines whether the endpoint device and the MFA-registered device are within a predetermined threshold proximity of each other. For example, in FIG. 1 the MFA service 108 determine whether the client device 102 and the MFA-registered device 104 are within a threshold proximity. With reference to FIG. 2, the MFA service 208 determines whether client device 202(A) and MFA-registered device 204 are within a threshold proximity. In addition, the MFA service 208 will determine whether client device 202(B) and MFA-registered device 204 are within the threshold proximity.

At operation 410, in response to the endpoint device and the MFA-registered device being within the threshold proximity to each other, the MFA service determines to allow a push notification to be transmitted to the MFA registered device requesting authentication to grant access to the user account by the endpoint device. For example, in FIG. 2 the MFA service 208 determines that client device 202(A) and MFA-registered device 204 are within the threshold proximity to each other. Thus, MFA service 208 sends an MFA push notification to MFA-registered device 204 to initiate a second factor authentication in for the MFA. The GPS location of the client device 202(A) and the MFA-registered device 204 may be continuously monitored throughout the life of the authenticated session such that when the MFA-registered device 204 does move away from the client device 202(A) and is more than the threshold proximity away from the client device 202(A), the MFA service may terminate the session.

At operation 412, in response to the endpoint device and the MFA-registered device not being within the threshold proximity to each other, the MFA device refrains from transmitting the push notification to the MFA-registered device. For example, in FIG. 2 the MFA service 208 determines that the client device 202(B) and the MFA-registered device 204 are not within the threshold proximity to each other and the MFA service refrains from sending a push notification to the MFA-registered device 204. Thus, preventing a potential endless stream of push requests and thwarting any attempt at inflicting MFA fatigue on the legitimate user of MFA-registered device 204. Additionally, in this example, the MFA service may conclude that the user credentials have likely been stolen based on the distance between GPS coordinates of the client device 202(B) and the MFA-registered device 204 as shown. Thus, the MFA service may send a notification to the MFA-registered device that the user credentials have likely been compromised and recommend or prompt the user of the MFA-registered device to change a password associated with the user account.

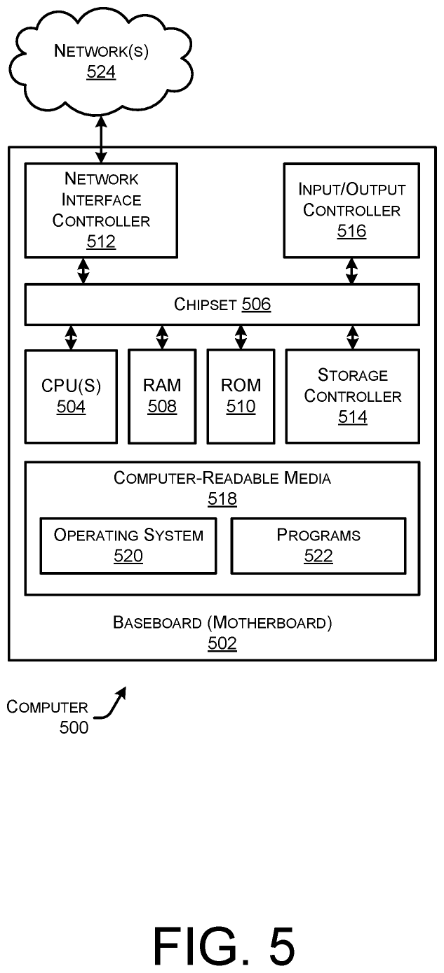

FIG. 5 is a computer architecture diagram showing an illustrative computer hardware architecture for implementing a computing device that can be utilized to implement aspects of the various technologies presented herein. The computer architecture shown in FIG. 5 illustrates a conventional server computer, network node (e.g., secure access node), router, workstation, desktop computer, laptop, tablet, network appliance, e-reader, smartphone, load balancer, or other computing device, and can be utilized to execute any of the software components presented herein.

The computer 500 includes a baseboard 502, or “motherboard,” which is a printed circuit board to which a multitude of components or devices can be connected by way of a system bus or other electrical communication paths. In one illustrative configuration, one or more central processing units (“CPUs”) 504 operate in conjunction with a chipset 506. The CPUs 504 can be standard programmable processors that perform arithmetic and logical operations necessary for the operation of the computer 500.

The CPUs 504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 506 provides an interface between the CPUs 504 and the remainder of the components and devices on the baseboard 502. The chipset 506 can provide an interface to a RAM 508, used as the main memory in the computer 500. The chipset 506 can further provide an interface to a computer-readable storage medium such as a read-only memory (“ROM”) 510 or non-volatile RAM (“NVRAM”) for storing basic routines that help to startup the computer 500 and to transfer information between the various components and devices. The ROM 510 or NVRAM can also store other software components necessary for the operation of the computer 500 in accordance with the configurations described herein.

The computer 500 can operate in a networked environment using logical connections to remote computing devices and computer systems through a network. The chipset 506 can include functionality for providing network connectivity through a NIC 512, such as a gigabit Ethernet adapter. The NIC 512 is capable of connecting the computer 500 to other computing devices over the network 524. It should be appreciated that multiple NICs 512 can be present in the computer 500, connecting the computer to other types of networks and remote computer systems. In some examples, the NIC 512 may be configured to perform at least some of the techniques described herein.

The computer 500 can be connected to a storage device 518 that provides non-volatile storage for the computer. The storage device 518 can store an operating system 520, programs 522, and data, which have been described in greater detail herein. The storage device 518 can be connected to the computer 500 through a storage controller 514 connected to the chipset 506. The storage device 518 can consist of one or more physical storage units. The storage controller 514 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 500 can store data on the storage device 518 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 518 is characterized as primary or secondary storage, and the like.

For example, the computer 500 can store information to the storage device 518 by issuing instructions through the storage controller 514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 500 can further read information from the storage device 518 by detecting the physical states or characteristics of one or more particular locations within the physical storage units.

In addition to the mass storage device 518 described above, the computer 500 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 500. In some examples, the operations performed by the architecture 100 and or any components included therein, may be supported by one or more devices similar to computer 500. Stated otherwise, some or all of the operations performed by the architecture 100, and or any components included therein, may be performed by one or more computer devices 500 operating in a scalable arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 518 can store an operating system 520 utilized to control the operation of the computer 500. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 518 can store other system or application programs and data utilized by the computer 500.

In one embodiment, the storage device 518 or other computer-readable storage media is encoded with computer-executable instructions which, when loaded into the computer 500, transform the computer from a general-purpose computing system into a special-purpose computer capable of implementing the embodiments described herein. These computer-executable instructions transform the computer 500 by specifying how the CPUs 504 transition between states, as described above. According to one embodiment, the computer 500 has access to computer-readable storage media storing computer-executable instructions which, when executed by the computer 500, perform the various processes and functionality described above with regard to FIGS. 1-4, and herein. The computer 500 can also include computer-readable storage media having instructions stored thereupon for performing any of the other computer-implemented operations described herein.

The computer 500 can also include one or more input/output controllers 516 for receiving and processing input from a number of input devices, such as a keyboard, a mouse, a touchpad, a touch screen, an electronic stylus, or other type of input device. Similarly, an input/output controller 516 can provide output to a display, such as a computer monitor, a flat-panel display, a digital projector, a printer, or other type of output device. It will be appreciated that the computer 500 might not include all of the components shown in FIG. 5, can include other components that are not explicitly shown in FIG. 5, or might utilize an architecture completely different than that shown in FIG. 5.

The computer 500 may include one or more hardware processors (processors) configured to execute one or more stored instructions. The processor(s) may comprise one or more cores. Further, the computer 500 may include one or more network interfaces configured to provide communications between the computer 500 and other devices. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 522 may comprise any type of programs or processes to perform the techniques described in this disclosure for using device proximity of a primary device and a secondary device to allow or deny connections to secured resource(s), as well as terminate existing connections to the secured resource(s).

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, at a Multi-Factor Authentication (MFA) service and from an application service, an indication of a request for a user account to access the application service via an endpoint device, the request including login credentials associated with the user account;
receiving, at the MFA service, a first geolocation of the endpoint device that sent the request;
receiving, at the MFA service, a second geolocation of an MFA-registered device that is associated with the user account;
determining, using the first geolocation and the second geolocation, whether the endpoint device and the MFA-registered device are within a threshold proximity to each other;
in response to the endpoint device and the MFA-registered device being within the threshold proximity to each other, determining, at the MFA service, to allow a push notification to be transmitted to the MFA-registered device requesting authentication to grant access to the user account by the endpoint device; and
in response to the endpoint device and the MFA-registered device not being within the threshold proximity to each other, refraining from transmitting the push notification to the MFA-registered device.

2. The method of claim 1, further comprising:
determining the endpoint device and the MFA-registered device are not with a threshold proximity to each other;
transmitting a notification to the MFA-registered device that the login credentials associated with the user account may have been stolen; and
prompting for a change to a password associated with the user account.

3. The method of claim 1, wherein the geolocation of the endpoint device and the geolocation of the MFA-registered device are determined using a Global Positioning System (GPS).

4. The method of claim 3, further comprising:
monitoring a GPS location of the endpoint device and a GPS location of the MFA-registered device; and
terminating a communication session between the endpoint device and the application service when a distance between the endpoint device and the MFA-registered device exceeds a predetermined range.

5. The method of claim 1, further comprising:
determining that the endpoint device and the MFA-registered device are not within a threshold proximity;
determining that the geolocation of the endpoint device is a predetermined acceptable geolocation associate with the user account; and
transmitting the push notification to the MFA-registered device requesting authentication to grant the endpoint device access to the user account.

6. The method of claim 1, wherein the user account is associated with an enterprise organization and the threshold proximity is determined according to a security policy of the enterprise organization.

7. The method of claim 1, further comprising:
determining that the endpoint device and the MFA-registered device are a same device;
receiving device information including International Mobile Equipment Identity (IMEI) from the same device;
determining whether the device information corresponds device information registered with the MFA service; and
in response to determining that the device information corresponds to device information registered with the MFA service, invoking a device biometric from an MFA application on the same device.

8. A system comprising:
one or more processors; and
one or more non-transitory computer-readable media storing instructions that, when executed, cause the one or more processors to perform operations comprising:
receiving, at a Multi-Factor Authentication (MFA) service and from an application service, an indication of a request for a user account to access the application service via an endpoint device, the request including login credentials associated with the user account;
receiving, at the MFA service, a first geolocation of the endpoint device that sent the request;
receiving, at the MFA service a second geolocation of an MFA-registered device that is associated with the user account;
determining, using the first geolocation and the second geolocation, whether the endpoint device and the MFA-registered device are within a threshold proximity to each other;
in response to the endpoint device and the MFA-registered device being within the threshold proximity to each other, determining, at the MFA service, to allow a push notification to be transmitted to the MFA-registered device requesting authentication to grant access to the user account by the endpoint device; and
in response to the endpoint device and the MFA-registered device not being within the threshold proximity to each other, refraining from transmitting the push notification to the MFA-registered device.

9. The system of claim 8, the operations further comprising:
determining the endpoint device and the MFA-registered device are not with a threshold proximity to each other;
transmitting a notification to the MFA-registered device that the login credentials associated with the user account may have been stolen; and
prompting for a change to a password associated with the user account.

10. The system of claim 8, wherein the geolocation of the endpoint device and the geolocation of the MFA-registered device are determined using a Global Positioning System (GPS).

11. The system of claim 10, the operations further comprising:
monitoring a GPS location of the endpoint device and a GPS location of the MFA-registered device; and
terminating a communication session between the endpoint device and the application service when a distance between the endpoint device and the MFA-registered device exceeds a predetermined range.

12. The system of claim 8, the operations further comprising:
determining that the endpoint device and the MFA-registered device are not within a threshold proximity;
determining that the geolocation of the endpoint device is a predetermined acceptable geolocation associate with the user account; and
transmitting the push notification to the MFA-registered device requesting authentication to grant the endpoint device access to the user account.

13. The system of claim 8, wherein the user account is associated with an enterprise organization and the threshold proximity is determined according to a security policy of the enterprise organization.

14. The system of claim 8, the operations further comprising:
determining that the endpoint device and the MFA-registered device are a same device;
receiving device information including International Mobile Equipment Identity (IMEI) from the same device;
determining whether the device information corresponds device information registered with the MFA service; and
in response to determining that the device information corresponds to device information registered with the MFA service, invoking a device biometric from an MFA application on the same device.

15. One or more non-transitory computer-readable media storing instructions that, when executed, cause one or more processors to perform operations comprising:
receiving, at a Multi-Factor Authentication (MFA) service and from an application service, an indication of a request for a user account to access the application service via an endpoint device, the request including login credentials associated with the user account;
receiving, at the MFA service, a first geolocation of the endpoint device that sent the request;
receiving, at the MFA service a second geolocation of an MFA-registered device that is associated with the user account;
determining, using the first geolocation and the second geolocation, whether the endpoint device and the MFA-registered device are within a threshold proximity to each other;
in response to the endpoint device and the MFA-registered device being within the threshold proximity to each other, determining, at the MFA service, to allow a push notification to be transmitted to the MFA-registered device requesting authentication to grant access to the user account by the endpoint device; and
in response to the endpoint device and the MFA-registered device not being within the threshold proximity to each other, refraining from transmitting the push notification to the MFA-registered device.

16. The one or more non-transitory computer-readable media of claim 15, the operations further comprising:
determining the endpoint device and the MFA-registered device are not with a threshold proximity to each other;
transmitting a notification to the MFA-registered device that the login credentials associated with the user account may have been stolen; and
prompting for a change to a password associated with the user account.

17. The one or more non-transitory computer-readable media of claim 15, wherein the geolocation of the endpoint device and the geolocation of the MFA-registered device are determined using a Global Positioning System (GPS).

18. The one or more non-transitory computer-readable media of claim 17, the operations further comprising:
monitoring a GPS location of the endpoint device and a GPS location of the MFA-registered device; and
terminating a communication session between the endpoint device and the application service when a distance between the endpoint device and the MFA-registered device exceeds a predetermined range.

19. The one or more non-transitory computer-readable media of claim 15, the operations further comprising:
determining that the endpoint device and the MFA-registered device are not within a threshold proximity;
determining that the geolocation of the endpoint device is a predetermined acceptable geolocation associate with the user account; and
transmitting the push notification to the MFA-registered device requesting authentication to grant the endpoint device access to the user account.

20. The one or more non-transitory computer-readable media of claim 15, wherein the user account is associated with an enterprise organization and the threshold proximity is determined according to a security policy of the enterprise organization.
